(19) United States
(12) Patent Application Publication
(10) Pub. No.: US 2026/0300294 A1
(43) Pub. Date: Oct. 1, 2026

(54) CONTEXT LOCALIZATION IMPLEMENTATION PIPELINE

(71) Applicant: Tellagence, Inc., Oregon City, OR (US)

(72) Inventors: Sharookh Daruwalla, Austin, TX (US); Nitin Mayande, Plain City, OH (US)

(21) Appl. No.: 19/575,335

(22) Filed: Mar. 23, 2026

Related U.S. Application Data
(60) Provisional application No. 63/778,407, filed on Mar. 27, 2025.

(51) Int. Cl. G06F 16/2453; G06F 16/215; G06F 16/28

(52) U.S. Cl. CPC G06F 16/24542; G06F 16/215; G06F 16/285

(57) ABSTRACT

Systems and methods for pipelined context localization, where the method comprises: receiving a plurality of queries for at least one data source; and processing each of the plurality of queries through a pipeline. The pipeline executes at least the following operations in order: hydrating, using a query from the plurality of queries, a plurality of data points obtained from at least one data source; unifying the plurality of data points; cleaning the plurality of data points; encapsulating the plurality of data points; and performing clustering analysis on the plurality of data points. When a first query of the plurality of queries has been processed through at least one operation of the pipeline, processing of a second query of the plurality of queries is commenced prior to the first query completing processing through the pipeline. Other embodiments are described.

### CROSS-REFERENCE TO RELATED APPLICATIONS

This application claims the benefit of U.S. Provisional Application No. 63/778,407, filed on 27 Mar. 2025, the contents of which are hereby incorporated into this application by reference as if fully set forth herein.

### TECHNICAL FIELD

The present invention relates generally to a systems and methods for efficient processing of queries against a plurality of data sources, and, in particular embodiments, to a system and method for pipelined processing of queries, summarization, and secondary analytics.

### BACKGROUND

Machine learning and artificial intelligence (AI) technology continues to evolve into increasingly useful tools that can be applied in a variety of different domains. ML systems include a wide variety of different types of algorithms that may enable a computer system to solve various problems, potentially in an adaptive fashion. ML systems may include statistical algorithms that can extrapolate patterns and/or general behaviors from specific data in a predictive fashion. AI technology, which is a subset or type of ML, includes a variety of different techniques and algorithms, including artificial neural networks (ANN). A subset of ANNs includes generative neural networks which, as the name suggests, can create various types of output based on an input prompt. Types of generative neural networks include large language models (LLMs), such as ChatGPT, and image generators, such as DALL-E, among others. For generally accessible implementations of generative AI systems such as ChatGPT and DALL-E, the systems are typically trained on vast amounts of data relevant to the AI system's operative modality, viz. text, images, etc., that may span a variety of different information domains. Other systems may be trained on more specific domains to form an expertise in a particular area. For example, some LLMs may be trained on social network data to provide predictive expertise on user behavior.

While the underlying implementations can vary, generative AI systems typically receive as input a query, such as a question in the form of one or more textual sentences (where the generative AI system input modality is text) or another appropriate input modality. The query is then fed into an input layer of the generative AI system. Generally speaking, generative AI systems are prediction engines, such that an answer to a query is generated by predicting what a next word, pixel, token, etc. (depending on the generative AI system output modality) would be based on the data set used to train the system and, in some implementations, previous predictions. Some generative AI systems also consider previous queries in providing answers, such as when a user has a “conversation” with the system, asking follow-up questions in response to predictions generated from earlier queries.

As mentioned above, types of generative AI may include image generators, which can create synthetic images of widely different types based upon provided user prompts, as well as synthetic motion video. Some such generative AI can employ the likeness of existing people in creating entirely synthetic images and video. Still other examples of generative AI can include music generation, and multi-modal AI which may be able to generate a variety of different types of media in response to user prompts.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram depicting the block components for a context localization process, according to various embodiments;

FIG. 2 illustrates the hierarchical structure applied to a large corpus of data for summarization, according to various embodiments;

FIG. 3 illustrates how the map-reduce technique is used to generate a summary of a large dataset, according to various embodiments;

FIG. 4 illustrates various stages of a pipelined context localization and secondary analytics process, according to various embodiments;

FIG. 5 illustrates the dispatch of several queries into the pipelined context localization and secondary analytics process, according to various embodiments;

FIG. 6 is a flow diagram of an example method for processing queries through a pipelined localization and secondary analytics process, according to various embodiments;

FIG. 7 is a flow diagram illustrating how a sequence coordinator directs various secondary analytics modules in conjunction with the pipeline to respond to a query, according to various embodiments;

FIG. 8 is a block diagram of an example computer that can be used to implement some or all of the components of the disclosed systems and methods, according to various embodiments; and

FIG. 9 is a block diagram of a computer-readable storage medium that can be used to implement some of the components of the system or methods disclosed herein, according to various embodiments.

### DETAILED DESCRIPTION OF ILLUSTRATIVE EMBODIMENTS

A system employing one or more machine learning (ML) systems (which can include an artificial intelligence (AI) system, such as a large language model (LLM) and/or another type of generative AI) may employ a context localization system to help provide results from a corpus of data that are relevant to a given organization or individual. The context localization process helps to enhance a prompt or query to the ML system to avoid possible hallucinations, provide disambiguation of a prompt or query that may be capable of several different interpretations, and/or to provide answers that are particularly relevant to the organization or individual. Such a system may be used with a plurality of different data sources, including publicly available sources such as social media feeds and other cloud services, as well as private data sources such as an organization's databases, libraries, e-mail collects, etc. With this array of different possible data sources, queries can be used to obtain summarizations and analytics such as sentiment analysis, categorization, and/or other useful information to help advance business goals.

In some cases, such a system may be provided by a third party vendor which may integrate an array of available social media feeds with various local data sources from vendor clients. In other cases, a larger organization may implement such a system in-house. In either scenario, such a system may be called upon to answer a variety of queries from users over time as business needs arise. Depending on the nature of a given query, a not insubstantial amount of compute time may be necessary to full a given query. Thus, there is a need for enhancements to such systems that can improve query throughput and optimize usage of computing resources.

Disclosed embodiments include a pipeline implementation for handling queries through a context localization, summarization, and analysis system. The pipeline breaks such a system down into various discrete stages that can execute in parallel with other stages. Thus, multiple queries can be submitted to a system and processed in parallel through the various stages, thereby improving overall query throughput. Various other embodiments are described herein.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

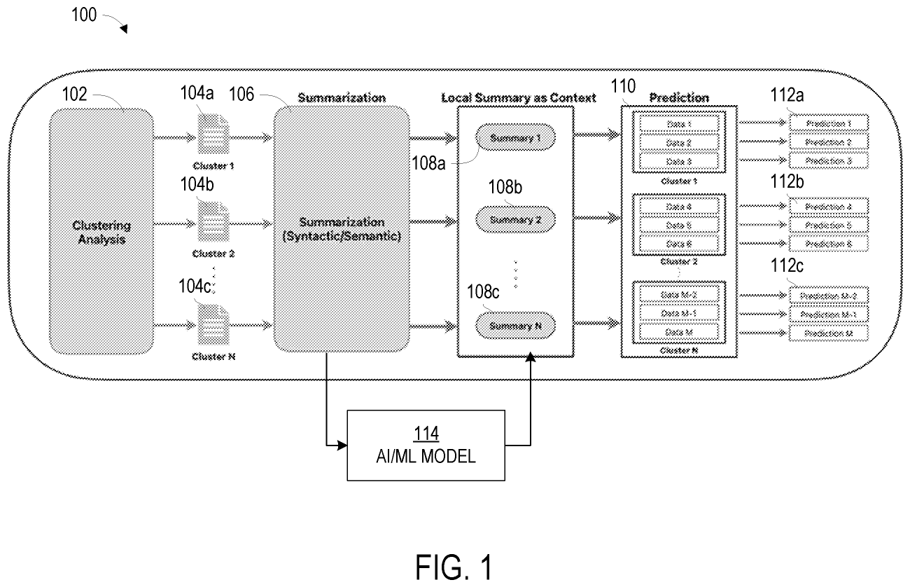

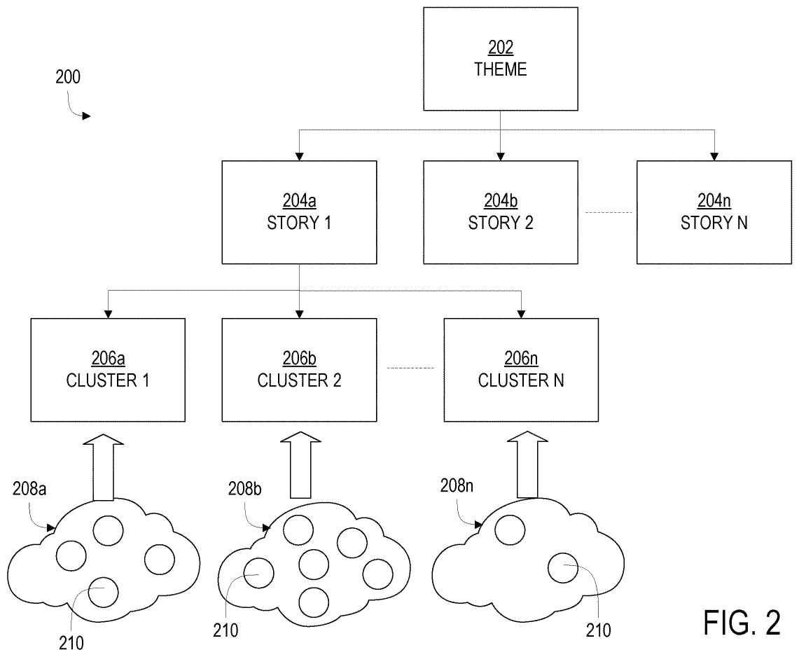

FIG. 1 illustrates the various components of a process flow 100 for a context localization process. As mentioned above, the context localization process may be performed in response to a query, to help ensure the query is correctly understood. Process flow 100 begins with a clustering analysis 102, which results in one or more clusters 104a to 104c. These clusters will be discussed in greater detail below, with reference to FIG. 2. It should be understood that the three illustrated clusters 104a, 104b, and 104c (generically, clusters 104) are merely an example; clustering analysis 102 may result in fewer or more clusters depending upon the nature of the data being processed and the specific requirements of a given implementation. The clusters 104 may then be summarized in a summarization operation 106, resulting in summaries 108a, 108b, and 108c (generically, summaries 108) that are useable as a context for a prompt to a generative AI, such as output predictions 112a, 112b, and 112c. The generative AI (or ML), which may be referred to as a target AI, is an AI or ML model that is used to analyze a corpus of data, and respond to queries about the corpus of data.

In clustering analysis 102, in some embodiments, relevant data points are formatted into similar clusters using one or more clustering algorithms. In embodiments, the clustering algorithms may group data with a similar context together, to drive the generative AI model to focus on the similar context resulting from the grouped data. In embodiments, relevant local data may be obtained from the corpus of data being summarized, where the corpus of data may be formed from one or more themes, discussed below with reference to FIG. 2.

In embodiments, one or more clustering algorithms may be used in conjunction with vector search indices to determine the relevant data from the corpus of local data. Examples of clustering algorithms that may be employed include Hierarchical Small Navigable World (HSNW), k-means, or any other algorithm now known or later developed that is suitable for use with process flow 100 and embodiments disclosed herein. In some embodiments, the clusters 104 may comprise vertices (e.g. data points, as discussed below with respect to FIG. 2) generated from local data embeddings, with each cluster 104 defined as comprising vertices that are within a predetermined threshold of a given target vertex. This helps ensure that the clusters 104a to 104c that are formed are semantically, syntactically, and/or contextually similar. Cluster IDs may then be assigned to each cluster and/or the vertices (or data points) that comprise each cluster. The end result is a series of clusters 104a to 104c that reflect various points of data that may share a similar context, within the corpus of data.

Once the clusters 104a to 104c are determined, in embodiments, they may be summarized in summarization operation 106. As noted in the depicted example in FIG. 1, summarization may involve syntactic analysis, semantic analysis, or a combination of both. Summarization, by definition, is the act of preparing a brief and succinct summary of a much larger corpus. Its primary advantage is that it provides the same pertinent and accurate information as the underlying data, but in a more compact and easily digestible package. For computing purposes, summarization can reduce the required overhead of system resources for processing and so decrease processing time, memory usage, and power consumption.

In some embodiments, the underlying context of each cluster 104 may be individually summarized using a suitable trained or configured AI/ML model 114. All data points within each cluster 104 may be arranged to form a single text data point (or another appropriate input mode if the AI/ML model 114 is so configured), coupled with a carefully designed input prompt, before inputting them into the AI/ML model 114. In some instances, the input to the AI/ML model 114 may comprise a context and a prompt. The context may be the summary of each cluster 104, of all datapoints within that cluster. The carefully designed input prompt may comprise a set of instructions to the AI/ML model 114 on what analysis needs to be performed. In embodiments, the summarization capability of the AI/ML 114 model may use an abstractive approach such that large text/datapoints are converted into a few sentences that capture a context (or most pertinent details) that is seen across the corpus of data.

These sentences (summaries) from the AI/ML model 114 comprise the summaries 108, with each of the summaries 108 corresponding to each of the clusters 104, viz. cluster 104a corresponds with summary 108a, cluster 104b corresponds with summary 104b, etc. Depending upon the functionality of the AI/ML model 114 and/or other components of an implementing system, the various vector representations of the relevant contextual data may be used to obtain the original raw data of the corpus of data, and/or to reference the original data for purposes of generating the summary sentences. It should be appreciated that while the foregoing example contemplates a text mode of input, this disclosure is not intended to be limited to only text-mode based systems. In other embodiments, different modes of entry (e.g. images, sounds, files, etc.) may be utilized. The input prompt(s) and/or the resulting summary may likewise be in a different mode. In still other embodiments, the resulting summary could be in a different mode from the input prompt(s), with the format and mode of the resulting summary determined by the requirements of the target generative AI system.

In embodiments, the summarization pipeline illustrated from clustering analysis 102 to the generated summaries 108 in process flow 100 may be part of a Map-Reduce approach, where a given corpus of data is too large to completely fit within the token limit size of a target AI or ML model, such as a generative AI system. In some such embodiments, the corpus of data is broken down via a hierarchical structure of clusters-stories-themes, which may be based on a predefined token size. This division operation is known as Map. Each hierarchical layer may be summarized iteratively, and the summaries of each layer combined to form a new summary data point. This summarization and combination operation is known as Collapse. The Collapse operation is repeated until the newly generated summary data point(s) is/are reduced into a single summary. This final reduction operation essentially provides a summary-of-summaries and is known as Reduce. The Map-Reduce summarization thus provides a scalable approach, and will be discussed in greater detail with reference to FIG. 2.

Once the various summaries 108 are obtained, they may be used to obtain one or more desired predictions in prediction operation 110. The predictions of prediction operation 110 may be any desired analysis or prediction, such as predictions 112a, 112b, and 112c, that the target ML model is capable of providing. As may be understood, the nature of such predictions may be constrained by the chosen target ML model. For example, in instances where the target ML model is an LLM, the prediction may be a text-based answer to the prompt. Similarly, in instances where the target ML model is an image generator, the prediction may be a desired image, rendered with consideration given to local context. Some possible use cases may also include, but are not limited to, sentiment analysis, summarization, translation, audience targeting, marketing, and the like.

In some specific examples, such as where the contextual data is (or is derived from) social media data, the prediction may be a summarization, or sentiment prediction or analysis, to name a few possibilities. In such an example, sentiment analysis or prediction, at a fundamental level, predicts the sentiment of the underlying information. Sentiment can be as simple as positive, negative, or neutral, or more complex or custom in nature. Predicting summarization and/or sentiment analysis for extremely large datasets, such as raw data feeds from a social media platform, coupled with ever changing communication style, is a non-trivial exercise, even when just for the English language. In the case of social media feeds, sentiment analysis or prediction involves analyzing social platform datasets to extract the underlying sentiment within the dataset interactions. Considering the relatively massive size of raw data from a social media feed, the amount of processing power and time required to perform sentiment prediction on the raw data would be immense, and potentially impossible to accomplish except on relatively high powered systems. However, context localization process flow 100 allows prediction operation 110 to be accomplished with considerably more modest equipment requirements, and/or in a parallel computing configuration, with multiple compute nodes each handling a summary operation.

In examples that are used for sentiment analysis (among other possible uses), summarizing the clusters from summarization operation 106 makes generating a sentiment prediction from the local summaries 108 simpler and accurate. With a carefully designed prompt that incorporates the localized context, instructions and individual data points, as discussed above, all combined as input, prediction operation 110 can generate Positive, Negative, or Neutral sentiment predictions 112a, 112b, and 112c (generically, sentiment predictions 112) for each corresponding local summary 108a, 108b, and 108c. In some embodiments, the sentiment predictions 112 may be generated by passing the carefully designed prompt to AI/ML model 114. In other embodiments, the sentiment predictions 112 may be generated by the target generative AI (which may be a part of AI/ML model 114 in some implementations). Furthermore, in still other embodiments, multiple local summaries 108 may be aggregated to form a single sentiment prediction 112. Along with sentiment predictions 112, the AI/ML model 114 (or target generative AI model if separate) may also provide a detailed explanation of the reasoning used to create the sentiment predictions 112.

FIG. 2 illustrates the hierarchical structure 200 by which a corpus of data is analyzed. The structure is comprised of a theme 202, which in turn may be comprised of a plurality of stories 204a to 204n (collectively or generically, story 204). Each of the plurality of stories 204 in turn may be comprised of a plurality of clusters 206a to 206n (collectively or generically, cluster 206). Each cluster 206 is comprised of a data point cloud such as point cloud 208a to 208n, and each point cloud 208 is comprised of one or more data points 210.

The one or more data points 210 all belong to the corpus of data (also called a dataset). As the data points 210 for the basis of the hierarchy of summaries, one or more themes 202 represent the corpus of data, as they inherently reflect the data points 210. In embodiments, each of the data points 210 is aggregated into their respective point clouds 208. These point clouds 208a, 208b, and through 208n may be considered clusters 206a, 206b, and through 206n (collectively or generically, cluster 206), respectively, in some implementations. In other implementations, the data points 210 in each point cloud 208 may be summarized to form each respective cluster 206. These clusters 206 may be formed from the data points 210, in some embodiments, using both syntactic and semantic similarities, as mentioned above with respect to FIG. 1. In still other embodiments, each cluster 206 may be or may be represented as a dictionary containing at least: 1) A summary of the cluster's contents, which may be textual and/or one or more other modes, as appropriate to the nature of the data and dataset. 2) A volume, which may comprise, for example, a number of social media comments associated with that cluster (in the case of the dataset being a social media feed or database), which can serve as a proxy for the cluster's significance or prevalence. It should be understood that the volume may comprise other types of data points where the dataset is some other type of database, where the other types of data point can likewise serve as a proxy for the cluster's significance/prevalence. 3) A list of salient keywords extracted from the data points from the cluster's comments or summary (or other data types depending on the nature of the dataset).

A group of clusters, here, clusters 206a, 206b, and through 206n, may in turn be summarized, to form a story 204a. In this sense, each of the clusters can be considered a data point that is used to form a given story 204. A group of stories, here, stories 204a, 204b, and through 204n, may similarly be summarized to form a theme 202. As with the clusters, each of the stores can be considered a data point that is used to form the given theme 202. Although not shown, there may be multiple themes 202, which collectively represent the entire corpus of data, including all data points 210. This breakdown of the data points into clusters with hierarchical summarization is a form of map-reduce.

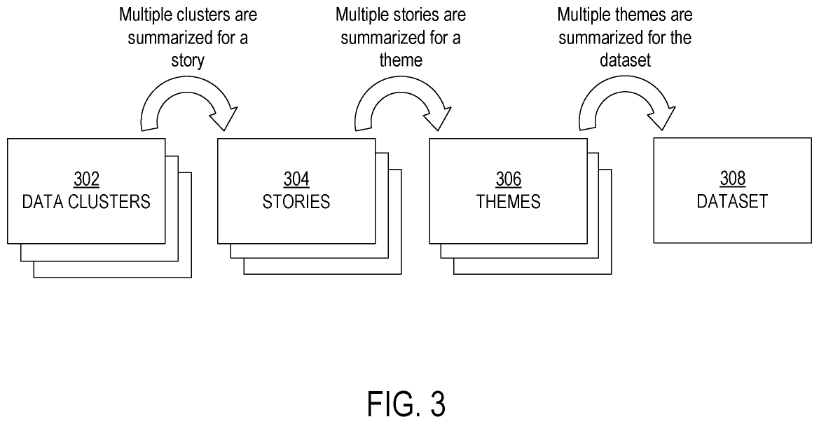

FIG. 3 illustrates in another fashion how a summary of summaries is produced via the map-reduce approach. Similar to as described above with reference to FIG. 2, multiple data clusters 302 are summarized to create each story 304. The clustering algorithm employed to create each data cluster 302 from the underlying data points may group data points together that have a similar context. In this sense, each cluster may form something of a local context for its specific data points.

Multiple stories 304 in turn are summarized to form a theme 306. As with the data points and clusters, the multiple stories 304 may be clustered together to form a given theme 306 on the basis of contextual similarity. As each story 304 derives its context from its constituent clusters 302, each story 304 essentially provides a more general or broader context compared with its lower level components.

Likewise, multiple themes 306 may be clustered to form the dataset 308. When summarized, a summary of summaries that reflects the dataset 308 is obtained. As mentioned above, these summaries may be driven or informed by a user query, which will act to direct how clustering and summarization is performed. In this sense, the user query can be considered as a context to drive the map-reduce and summarization processes.

It should be appreciated that, since the sub-clusters are independent, the AI/ML model 114 (and/or another model or models used to perform clustering and/or summarization) can be configured to run in parallel on the individual sub-clusters.

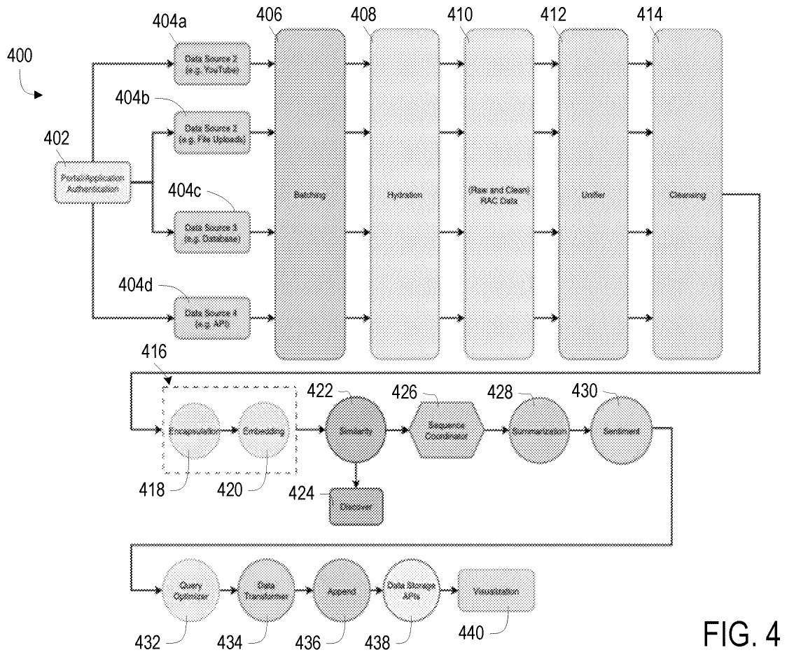

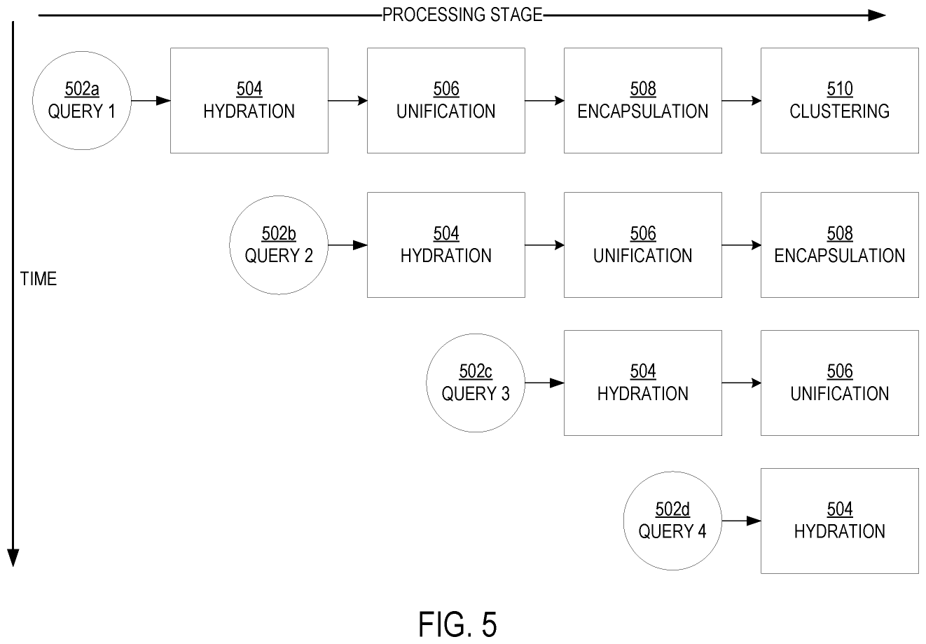

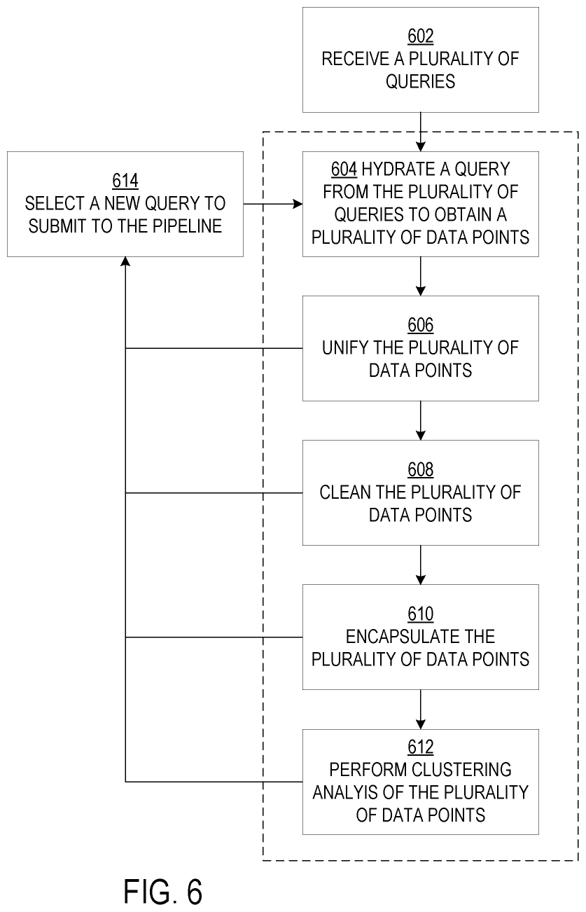

FIG. 4 illustrates various stages of an example implementation of a pipeline 400 for a context localization and secondary analytics process. The process may accept a plurality of queries directed to a variety of data sources 404a-404d, then summarize and analyze the data obtained from the data sources 404a-404d in response to processing the queries. The pipeline 400 may implement operations for context localization, summarization, and analysis, as needed by a given embodiment. One or more of the various stages (described below) of pipeline 400 may execute in parallel, so that data responsive to each of the plurality of queries may be processed at a different stage of the pipeline 400. This scheme will be discussed in greater detail below with respect to FIGS. 5 and 6.

Pipeline 400, in embodiments, may commence with a portal or application authentication 402. Depending on the nature of the various data sources 404a-404d, a user submitting a query to pipeline 400 may only be allowed to access a subset of the various data sources 404a-404d, and/or may be required to provide identification at access the data sources 404a-404d, such as for purposes of logging access, activity, billing, etc.

Data sources 404a-404d may comprise a variety of related or unrelated repositories of data that is potentially relevant to a given query submitted to the pipeline 400 for processing. In the example illustrated in FIG. 4, data source 404a may be a publicly available service such as YouTube, or another social media service such as Facebook, TikTok, etc. Data source 404b may be a private or local data source, such as a collection of file uploads or a file repository on a server or cloud storage. Data source 404c may be a local database that is specific to a given user of the pipeline 400. Data source 404d may be an application programming interface (API) for interfacing with a business application (which itself may provide access to a database) or a publicly available service, such as a social media feed that provides a public-facing API. It should be understood that data sources 404a-404d are merely example data sources. Furthermore, the data sources may not be limited to just single instances of the types of data sources 404a-404d. A given embodiment may have multiple social media data sources, e.g. it may pull from Facebook, TikTok, Instagram, and YouTube, each as a separate data source. A given embodiment of pipeline 400 may also have more or fewer data sources, and the data sources may be of a different nature than those illustrated in FIG. 4. For example, a possible implementation of pipeline 400 that is controlled by a single organization may have data sources that are predominantly or wholly internal data sources, and may even exclude public sources. Another possible implementation may be exclusively public data sources, such as a service offering analytics of social media representation. As with the example of FIG. 4, some implementations may be a hybrid of public and private data sources, such as where a business wishes to perform social media analytics on its products/services, and will also include local data sources to provide context localization for query responses that are more accurate to the business needs.

With this understanding of the various data sources 404a-404d, it should be understood that portal/application authentication 402 may include any necessary credentials to access the various public and private data sources 404a-404d. As mentioned above, in some cases a user may be restricted from accessing particular data sources for various reasons (e.g. data privacy restrictions, unsubscribed services, etc.), in which case the portal/application authentication 402 would only allow queries to be processed against data sources the user is allowed to access. The portal/application authentication 402 may use any suitable mechanism to authenticate a user/query, as may be appropriate to a given implementation.

Each of the data sources 404 (generic for data sources 404a-404d) feeds into a batching stage 406. The batching stage 406, in embodiments, may be responsible for collecting a plurality of data points from the various data sources 404 that are queried. In some embodiments, a given query may need to be submitted to some or all of the data sources 404. The batching stage 406 may coordinate duplication and submission of the query to each of the needed data sources 404, and, in some implementations, collection of the resulting plurality of data points from each respective queried data source 404. In other implementations, the batching stage 406 may only submit the queries, with collection of the resulting data points handled by the subsequent hydration stage 408 (discussed immediately below).

In other embodiments, the batching stage 406 may (also) coordinate dispatching a plurality of queries to each of the appropriate data sources 404. For example, five queries may be submitted that will require data points from data source 404a. Batching stage 406 may collect the five queries together so that they can be submitted to data source 404a, thereby collecting all necessary data points for processing each of the queries in a single session (or batch), so that the pipeline 400 may operate efficiently. Furthermore, this collection of queries by the batching stage 404 may help decrease communication bandwidth and/or load with the various data sources 404 by essentially bursting queries, saving on additional overhead that may be incurred when submitting each query separately.

In still other embodiments, the batching stage 406 may (also) divide the input data (e.g. plurality of data points) into a plurality of smaller subsets to allow for easier processing and/or scaling. For example, if the queries result in a relatively large size of the plurality of data points, it may be necessary in some implementations to process the data in a plurality of subsets to stay within constraints or limitations of the system implementing the pipeline 400. In other implementations, if the nature of the plurality of data points permits and/or if the plurality of data points is an aggregated response to a plurality of queries, dividing the plurality of data points into a plurality of subsets may allow each subset to be processed in parallel, with the subsets being distributed over a number of different processing nodes. It should also be recognized that, particularly (but not limited to) when the plurality of data points can be grouped into subsets based on relevant queries, such division into subsets can facilitate scaling of the pipeline 400, such as by adding additional computing nodes/resources.

The results of the batching stage 406, i.e. the plurality of data points from each of the data sources 404 that are responsive to various submitted queries, may next be provided to the hydration stage 408. In the hydration stage 408, the data points are collected from the various queried data sources 404 or, depending on a given embodiment, may be collected from the batching stage 404, such as from a buffer or other suitable data storage. In embodiments, the hydration stage 408 may retrieve the data points from the various data sources 404 via any suitable mechanism (e.g. API data pulls, file-uploads, etc.). Once collected, the data points may be stored in a pipeline storage collection. The pipeline storage collection may be any suitable data storage from which the plurality of data points may be subsequently retrieved as needed. It should be understood that, depending on the needs of a given embodiment, the pipeline storage collection may be accessed by subsequent pipeline stages described herein, rather than the plurality of data points being copied or transferred between buffers or separate storage from stage to stage.

In some alternative embodiments, queries may be dispatched to the batching stage 406 and/or the hydration stage 408, rather than to each individual data source 404. In such cases, the various data sources may rather be queried in a general fashion to create a collection of raw and client data points, which are then processed through the pipeline stages to form a context-localized corpus of data, against which user queries may be performed. This corpus of data may be subsequently processed by various stages of the pipeline 400 as needed in response to the user queries. For purposes of this discussion, however, it is assumed that user queries are accepted for dispatch to each individual data source 404 as determined by the batching stage 406 and/or hydration stage 408.

The pipeline storage collection, following hydration stage 407, may include raw and clean data 410. The raw data may be data obtained from various external or generic (e.g., non-client specific) sources, such as a social media feed. Clean data, as the name implies, may comprise otherwise raw data that has been cleaned or otherwise pre-processed; this data may undergo further cleaning in the cleaning stage 414, discussed below. The raw and clean data may also include any client data that was provided as part of the context for a query being processed and/or data retrieved from client-owned or controlled data sources that form a localized context for subsequent processing of the data points obtained from the query. In some embodiments, client data may may also include the query itself.

Once the raw and clean data 410 has been obtained from the batching stage 406 and the hydration stage 408, in the data unification (or data unifier, or unifier) stage 412, the plurality of data points are mapped according to a source and destination field mapping, viz. data from various different data sources 404 is mapped according to an understanding of the nature of data from each data source 404 (e.g., one or more source fields) and how it can relate (map0 to a single corresponding (unified) field in a unified plurality of data points. For example, a user identifier field may be present in a plurality of the data points that is labeled and/or formatted differently by each respective data source 404. These various identifiers may be mapped to a single field for a user identifier in the unified plurality of data points. Likewise, various content fields may have different labels depending on the source data source 404 while holding data of a common nature; each data source 404 may have a corresponding mapping in the unification stage 412 that associates the label of the particular data source 404 with a single destination label for the unified plurality of data points. In some cases, the raw data may require further input from a user to clarify or identify the nature of some data points for a given data source 404 (e.g. we may need the user to identify the content of certain fields i.e. date of a given event, nature/subject of a text field, etc.), so that the data can be properly mapped from the given data source 404 to the appropriate common fields in the unified plurality of data points. The result is a corpus of data points, responsive to a given query, from a plurality of different data sources 404 that can be understood and processed in a unified fashion, without having to accommodate disparate field names that otherwise represent a common type of data.

The unification stage 412 may alternatively or additionally, in some embodiments, serve to reunite data that was split into subsets in the batching stage 406, so that the plurality of data points can be analyzed as a whole corpus of unified data points in the subsequent analytic stages. In this sense, the unification stage 412 can essentially act as a reverse of the process carried out in the batching stage 406.

Once the plurality of data points have been unified, raw text data may be fetched and appended with cleansed data, in the cleansing stage 414. Data cleansing, in embodiments, may include the following processes: Remove punctuations, URLs, and stop-words; Lemmatization; Extract/Remove any hashtags and/or emojis; Extract any relevant keywords/phrases. In embodiments, the extraction of keywords/phrases as relevant may be determined based on the query and any relevant localized context. Identification and extraction of such relevant keywords/phrases may be accomplished by a suitable ML or AI system, in embodiments, or any other suitable algorithm or technique.

Stages 406 through 414 may comprise a data fetching and preparation pipeline, with the result of cleansing stage 414 being a corpus of data points, relevant to a given query, that are ready for further analysis. Such analysis may be performed by a suitable ML or AI system, in various embodiments. The different types of analysis will be described below with respect to the remaining stages.

Once the unified and cleansed corpus of data points have been obtained following cleansing stage 414, the encapsulation stage 416 includes an encapsulation process 418, where data is grouped, such as at a cadence-based encapsulation level. The cadence, in embodiments, may be temporal, and can be at a {Daily, Weekly, Bi-Weekly, Monthly, Quarterly, Annual, or All-at-once} level. Thus, the corpus of data points may be encapsulated into various subsets according to one or more temporal levels. For example, a daily encapsulation may split or otherwise group the corpus of data points into sets with a common day (which may have been identified in the unification stage 412. The encapsulation stage 416 may also include an embedding generation process 420, where embeddings are generated for the main-text field of the data points, in the corpus of data points, for similarity analysis (discussed below).

In the similarity stage 422, the plurality of data points from the corpus of data points are grouped into clusters based on a specified similarity threshold. Each data point in the corpus of data points may then be updated with its associated cluster ID (see FIG. 1 above) in pipeline database/storage collection. In embodiments, the similarity threshold may be used in various clustering algorithms or other approaches to clustering to calculate a similarity between the embeddings generated in the encapsulation stage 416. The greater the semantic resemblance between the summaries of any two clusters, the higher the resulting similarity. In some embodiments, the similarity may be a cosine similarity. In other embodiments, different types of techniques may be employed to compute a similarity, depending on the needs of a given embodiment. Where the algorithm, in a given embodiment, determines that two given data points meet and/or exceed the similarly threshold with respect to each other, the two given data points may be placed into the same cluster. An example of clustering is illustrated in FIG. 2, and the reader is directed to the corresponding description above.

As part of the similarity process, in the discover stage 424, the clusters may further be classified into themes and stories. Each theme has keywords and each datapoint within the dataset is classified in one theme only. Similarly, each story has key phrases. The reader is again referred to FIG. 2 and its corresponding description, as well as FIG. 3 and its corresponding description.

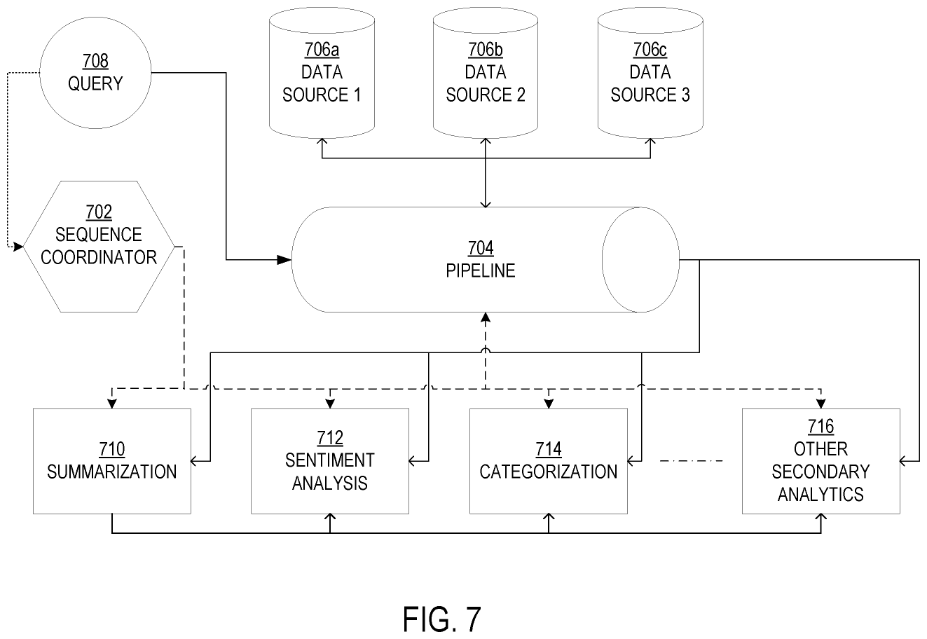

Following generation of the clusters, themes, and stories, the corpus of data points (now organized into the aforesaid clusters, themes, and stories) are in condition for analysis, including secondary analytics. A sequence coordinator 426 coordinates between the various secondary analytic stages as well as the previously discussed stages of pipeline 400. For example, the operation of the unification stage 412 may be adjusted (e.g. different fields may be assigned) depending on which particular secondary analytics are to be performed on the corpus of data. For example, a particular user submitting a query may only be permitted to perform certain secondary analytics, such as due to permissions and/or subscription (e.g. the analytics may be provided by a third party, and the user may have only opted to subscribe to certain types of analytics). The operation of the sequence coordinator 426 will be discussed further below with respect to FIG. 7.

The following analytics stages, it should be understood, may not be performed in all instances and/or available in every embodiment. Furthermore, these analytics stages are provided by way of example. Some embodiments may offer additional analytics that are not described here. For a non-limiting example, categorization may be provided as a secondary analytic, where the corpus of data is broken down and sorted into various relevant categories, which may be predefined and/or automatically determined.

It should further be understood that these various analytics stages may be performed by one or more suitable ML or AI systems, which may, in some embodiments, be specifically trained or otherwise configured to perform the indicated analysis on the corpus of data points.

In the summarization stage 428, summaries are generated for each unique cluster and unique story resulting from the similarity stage 422 and discover stage 424. There are three types of summaries that may be generated: clusters; stories; and themes. These various summaries are described in greater detail above with respect to FIG. 3 and its corresponding description. The result may be a “summary of summaries” at the theme level. These summaries may also form the basis for secondary analytics performed in subsequent stages, and so in some embodiments, the summarization stage 428 may be a necessary precursor to the following stages. In other embodiments, subsequent analytics may be performed to some extent without the need of the summarization stage 428; in such embodiments, the summarization stage 428 may be optional.

For the sentiment analysis stage 430, a sentiment analysis may be generated for each cluster, story, and theme summary (which may be obtained from the previous summarization stage 428, as discussed immediately above), along with a corresponding reasoning. Sentiment analysis, in some embodiments, may include ascertaining whether feedback for a given service, product, or other relevant aspect is positive, negative, neutral, or another general impression. In embodiments, the sentiment analysis stage 430 can be done in batches for large volumes of data, such as when a given corpus of data is above a predetermined threshold. The threshold may be determined based on the capabilities of a given implementing system. To perform sentiment analysis, a single prompt to an AI or ML system may be created with multiple records to obtain sentiment and explanation responses to reduce generative AI model calls. While the term “prompt” is used here, “prompt” should be understood to mean any way of asking or instructing the system (such as the sentiment analysis stage 430 and/or any other appropriate stage) to perform sentiment analysis or another analysis that provides the necessary context and instructions for performing the desired analysis. “Prompt” is not intended to imply any specific way of instructing the system to perform sentiment analysis.

In some implementations, sentiment analysis is generated for cluster summaries along with their corresponding reasonings, with prompts being created for each record in each cluster. Sentiment analysis may further be performed on higher levels, including stories and/or themes, depending on the needs of a given user. In such cases, the sentiment analysis stage 430 may generate further prompts for each story and/or theme to obtain sentiment analysis. Where multiple sentiment analyses are obtained from a corpus of data, further summarization of the analysis may also be performed.

The following pipeline stages may provide additional functionality and/or interoperability with the pipeline 400 and its associated results, for use with various front-end systems that query into the pipeline 400. The results may include the various summaries and analyses from the analytical stages, the corpus of data responsive to the query, and/or relevant contextual data, e.g. data used for context localization.

In the query optimizer stage 432, data (results from the foregoing analytical stages) may be pre-processed for an API server, allowing the API server to retrieve data directly from the context data collection (used as part of the various analytical stages) instead of generating it on the fly. This optimization can reduce API response times and so may improve overall system performance. The API server may allow the results from the secondary analytics to be delivered to any suitable front-end that is programmed or otherwise configured to obtain the results from the pipeline 400.

In the data transformer stage 434, in embodiments a data fetch is performed from the database/pipeline storage collection. The data may be processed, and then inserted into a transformed collection based on a payload for processing/transformation. The payload may be provided by a user, so that the data fetched from the pipeline storage or database can be processed/transformed according to the user's specific needs.

In the append stage 436, a data fetch is performed from the transformed database/storage collection. The data is then processed, and inserted into a final location (e.g. a user database such as MySQL or BigQuery tables) based on the provided payload. As with the data transformer stage 434, the payload may be provided by a user to accommodate the user's specific needs.

In the data storage API stage 438, as discussed above with respect to the query optimizer stage 432, various results from the pipeline 400 may be stored for retrieval via an application programming interface (API). The API may be specified and public so that front end interfaces can be used to retrieve, manipulate, and/or use the results from various stages of the pipeline 400, as discussed above.

Finally, in visualization stage 440, the data and analysis results from the pipeline 400 may be presented to a user in a suitable format for use. The visualization stage 440 may be a front end, and may access the data to be visualized from the data storage API discussed immediately above.

FIG. 5 illustrates operation of the pipeline (such as the pipeline 400 discussed above with respect to FIG. 4), with the dispatch of several queries into the pipelined context localization and secondary analytics processes. It will be understood that not all stages of the pipeline 400 are illustrated nor is its full functionality depicted, as only the operational concepts of the pipeline are discussed. The reader is directed to FIG. 4 above and the associated description for a comprehensive discussion of the various stages of the pipeline 400.

As can be seen in FIG. 5, a series of stages are executed in order in the pipeline, with the processing stage for a given query illustrated from left to right. The time that each query is dispatched and processed through each subsequent stage is illustrated from top to bottom. A first query 502a at an initial time may be dispatched into the pipeline, commencing with the hydration stage 504. Once the first query 502a has finished processing through the hydration stage 504, it proceeds to a unification stage 506.

With the hydration stage 504 now available and while the first query 502a is in the unification stage 506, a second query 502b may be dispatched to the hydration stage 504. Once the first query 502a completes the unification stage 506, it proceeds to the encapsulation stage 508, freeing the unification stage 506. The second query 502b may then proceed to the unification stage 506, freeing the hydration stage 504.

With the hydration stage 504 once again available, a third query 502c is dispatched to the hydration stage 504. As the third query 502c is processed, the first query 502a may proceed from the encapsulation stage 508 to the clustering stage 510, freeing the encapsulation stage 508. The second query 502b may then proceed from the unification stage 506 to the encapsulation stage 508, freeing the unification stage 506. The third query 502c may then proceed from the hydration stage 504 to the unification stage 506, once again freeing the hydration stage 504. With the hydration stage 504 freed, a fourth query 502d is dispatched to the hydration stage 504.

Thus, it will be appreciated that, over time, each stage of the pipeline can be working on a different query simultaneously. By the time the fourth query 502d is dispatched, all four queries are being processed simultaneously, with the first query 502a in the clustering stage 510, the second query 502b in the encapsulation stage 508, the third query 502c in the unification stage 506, and the fourth query 502d in the hydration stage 504. This simultaneous processing allows for substantially greater throughput from the pipeline than would be possible if each query had to complete all processing stages before a new query could be dispatched.

It should further be understood that, depending on how each of the various pipeline stages is implemented in a given embodiment and the sorts of data dependencies subsequent stages may have, some pipeline stages may necessarily need to fully complete on a given query or queries before subsequent pipeline stages can be commenced.

FIG. 6 is a flow diagram of an example method for processing queries through a pipelined localization and secondary analytics process, such as discussed above with respect to pipeline 400 (FIG. 4). The method depicted in FIG. 6 is essentially the flow described above with respect to FIG. 5. The various operations described below correspond to similar stages discussed above with respect to FIG. 4. The reader is directed to FIG. 4 and its associated discussion for further details that will not be repeated here.

In operation 602, a plurality of queries may be received. One of the queries may be selected from the plurality of queries, such as in order of receipt (with the oldest query having highest priority) and/or based on an assigned priority (e.g. some queries may be designated as having higher priority over others).

In operation 604, the selected query is hydrated to obtain a plurality of data points. This corresponds to the hydration stage 408 of pipeline 400.

In operation 606, once hydration is complete, the plurality of data points are unified. This corresponds to the unifier stage 412 of pipeline 400. With the hydration complete, at operation 614, a new query may be selected per operation 602 and dispatched for hydration per operation 604.

In operation 608, once the plurality of data points are unified, the plurality of data points is cleaned. This corresponds to the cleaning stage 414 of pipeline 400. With unification complete, the data points from the new query from operation 614 may proceed from operation 604 to 606 for unification and, once again, operation 614 may be invoked to select another new query and dispatch it for hydration per operation 604, once the previous new query data points are in operation 606.

In operation 610, once the plurality of data points are cleansed, the plurality of data points are encapsulated. This corresponds to the encapsulation stage 416 of pipeline 400. With cleansing complete, the data points from the query in operation 606 may proceed to operation 608 for unification, and the data points from the query in operation 604 may proceed to operation 606 for unification. Once again, operation 614 is invoked to select another new query, which is dispatched to operation 604.

In operation 612, once the plurality of data points have been encapsulated, they proceed to clustering analysis. This corresponds to stages 422 and 424 of pipeline 400. With encapsulation complete, the data points from the query in operation 608 may proceed to operation 610, the data points from the query in operation 606 may proceed to operation 608, and the data points from the query in operation 604 may proceed to operation 606. Once again, operation 614 is invoked to select yet another new query, which is dispatched to operation 604.

FIG. 7 is a flow diagram illustrating how a sequence coordinator 702 (corresponding to the sequence coordinator 426 described above with respect to FIG. 4) directs various secondary analytics modules in conjunction with the pipeline to respond to a query. Sequence coordinator 702 may be implemented in software, hardware, or a combination of both. Sequence coordinator 702 may be a part of pipeline 400, or may be a separate module or system that acts to control (aspects of) the pipeline 400.

As can be seen, sequence coordinator 702 is in control communication with pipeline 704, as well as various analytical stages summarization 710, sentiment analysis 712, categorization analysis 714, and possibly one or more other secondary analytics 716. Sequence coordinator 702 also received a query 708 in various embodiments, which is to be dispatched to pipeline 704. The query 708 can be analyzed by sequence coordinator 702 to understand which particular secondary analytics will be employed and, with this information, coordinate the operation of the various stages of the pipeline 704 (not illustrated) to provide the necessary corpus of data in a proper format for each of the secondary analytics stages to be employed.

Pipeline 704 submits queries and receives data from one or more of the example data sources 706a-706c. Which data sources are selected may, in some embodiments, be instructed or otherwise controlled by the sequence coordinator 702.

Pipeline 704, following processing in coordination with the sequence coordinator 702, provides the appropriate corpus of data to each secondary analytic stage to be used. Furthermore, the summarization stage 710 may feed into each of the other secondary analytic stages, as shown and as discussed above with respect to FIG. 4.

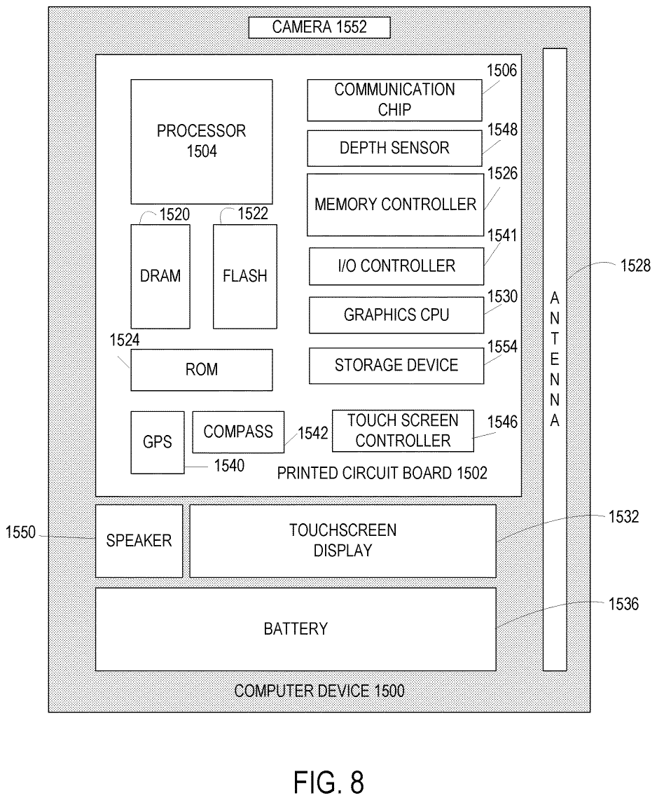

FIG. 8 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of embodiments of FIGS. 1-7 as described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

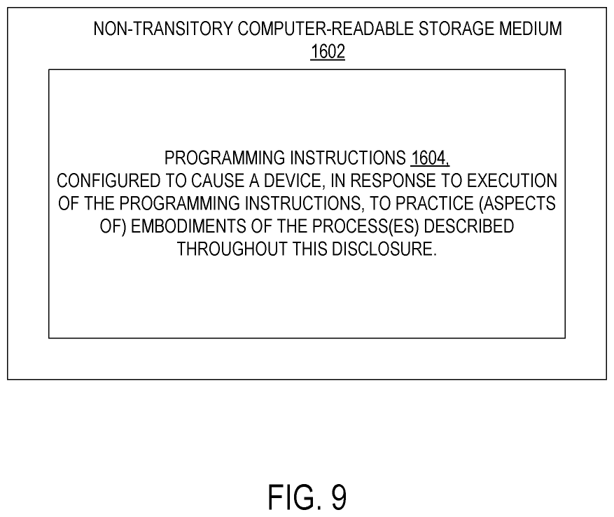

FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) embodiments of FIGS. 1-7 as described herein. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for pipelined context localization, comprising:
receiving a plurality of queries for at least one data source; and
processing each of the plurality of queries through a pipeline, the pipeline comprising execution of the following operations in order:
hydrating, using a query from the plurality of queries, a plurality of data points obtained from at least one data source;
unifying the plurality of data points;
cleaning the plurality of data points;
encapsulating the plurality of data points; and
performing clustering analysis on the plurality of data points,
wherein when a first query of the plurality of queries has been processed through at least one operation of the pipeline, processing of a second query of the plurality of queries is commenced prior to the first query completing processing through the pipeline.

2. The method according to claim 1, wherein hydrating the plurality of data points from the at least one data source comprises:
retrieving, using the query from the plurality of queries, the plurality of data points from the at least one data source; and
storing the plurality of data points into a pipeline storage collection for processing through subsequent operations of the pipeline.

3. The method according to claim 2, wherein the pipeline further comprises batching, prior to hydrating, a series of queries directed to the at least one data source.

4. The method according to claim 1, wherein unifying the plurality of data points comprises:
mapping the plurality of data points from a plurality of sources according to a source and destination field correspondence to obtain a single combined data source; or
unifying a plurality of subsets of the plurality of data points to obtain the single combined data source.

5. The method according to claim 1, wherein encapsulating the plurality of data points comprises:
splitting the plurality of data points on a time-series basis; and
generating embeddings for a main text field for similarity analysis.

6. The method according to claim 1, wherein performing clustering analysis on the plurality of data points comprises:
clustering the plurality of data points into one or more clusters;
classifying the one or more clusters into one or more stories;
classifying the one or more stories into one or more themes; and
performing summarization for each unique cluster of the one or more clusters, for each unique story of the one or more stories, or for each unique theme of the one or more themes, to obtain respective one or more cluster summaries, one or more story summaries, or one or more theme summaries.

7. The method according to claim 6, further comprising generating a sentiment analysis for each cluster summary, story summary, or theme summary.

8. The method according to claim 7, wherein generating the sentiment analysis comprises generating a single prompt using multiple records to obtain a sentiment and explanation response.

9. The method according to claim 1, wherein performing clustering analysis on the plurality of data points further comprises:
creating one or more clusters of the plurality of data points based on a similarity threshold; and
updating cluster IDs in a pipeline storage collection to reflect the one or more clusters.

10. The method according to claim 1, further comprising determining, with a sequence coordinator, a sequence of one or more analysis modules that are part of the pipeline for analysis of the plurality of data points.

11. A non-transitory computer-readable medium (CRM), comprising instructions that, when executed by at least one processor of a device, cause the device to perform:
receiving a plurality of queries for at least one data source; and
processing each of the plurality of queries through a pipeline, the pipeline comprising execution of the following operations in order:
hydrating, using a query from the plurality of queries, a plurality of data points obtained from at least one data source;
unifying the plurality of data points;
cleaning the plurality of data points;
encapsulating the plurality of data points; and
performing clustering analysis on the plurality of data points,
wherein when a first query of the plurality of queries has been processed through at least one operation of the pipeline, processing of a second query of the plurality of queries is commenced prior to the first query completing processing through the pipeline.

12. The CRM according to claim 11, wherein the instructions for hydrating the plurality of data points from the at least one data source further cause the device to perform:
retrieving, using the query from the plurality of queries, the plurality of data points from the at least one data source; and
storing the plurality of data points into a pipeline storage collection for processing through subsequent operations of the pipeline.

13. The CRM according to claim 12, wherein the instructions for the pipeline further cause the device to perform batching, prior to hydrating, a series of queries directed to the at least one data source.

14. The CRM according to claim 11, wherein the instructions for unifying the data points further cause the device to perform:
mapping the plurality of data points from a plurality of sources according to a source and destination field correspondence to obtain a single combined data source; or
unifying a plurality of subsets of the plurality of data points to obtain the single combined data source.

15. The CRM according to claim 11, wherein the instructions for encapsulating the data points further cause the device to perform:
splitting the plurality of data points on a time-series basis; and
generating embeddings for a main text field for similarity analysis.

16. The CRM according to claim 11, wherein the instructions for performing clustering analysis on the data points further cause the device to perform:
clustering the data points into one or more clusters;
classifying the one or more clusters into one or more stories;
classifying the one or more stories into one or more themes; and
performing summarization for each unique cluster of the one or more clusters, for each unique story of the one or more stories, or for each unique theme of the one or more themes, to obtain respective one or more cluster summaries, one or more story summaries, or one or more theme summaries.

17. The CRM according to claim 16, wherein the instructions further cause the device to perform generating a sentiment analysis for each cluster summary, story summary, or theme summary.

18. The CRM according to claim 17, wherein the instructions for generating the sentiment analysis further cause the device to perform generating a single prompt using multiple records to obtain a sentiment and explanation response.

19. The CRM according to claim 11, wherein the instructions for performing clustering analysis on the data points further cause the device to perform:
creating one or more clusters of the data points based on a similarity threshold; and
updating cluster IDs in a pipeline storage collection to reflect the one or more clusters.

20. The CRM according to claim 11, wherein the instructions further cause the device to perform determining, with a sequence coordinator, a sequence of one or more analysis modules that are part of the pipeline for analysis of the plurality of data points.
